(19) United States
(12) Patent Application Publication
(10) Pub. No.: US 2026/0287491 A1
(43) Pub. Date: Sep. 24, 2026

(54) DETERMINING REMOVAL EFFICIENCY OF FILTER MATERIALS

(71) Applicant: CPS Technology Holdings LLC, New York, NY (US)

(72) Inventor: Jeramy William LEMIEUX, Mukwonago, WI (US)

(21) Appl. No.: 19/474,559

(22) PCT Filed: Apr. 12, 2024
(86) PCT No.: PCT/US2024/024390

§ 371 Date: Oct. 10, 2025

Related U.S. Application Data
(60) Provisional application No. 63/496,227, filed on Apr. 14, 2023.

(51) Int. Cl. G01N 15/08

(52) U.S. Cl. CPC G01N 15/0806; G01N 2015/084

(57) ABSTRACT

A testing system comprising a first filter, a second filter, a first sampling filter, and a second sampling filter is described. The first filter is arranged to receive air and perform a first stage filtering of the air. The second filter is arranged to receive air from the first filter after the first stage filtering is performed and to perform a second stage filtering of the air. The first sampling filter is positioned between the first and second filters, arranged to receive the air that is effluent from the first filter after the first stage filtering is performed, and arranged for testing efficiency of the first stage filtering. The second sampling filter is arranged to receive the air that is effluent from the second filter after the second stage filtering is performed and arranged for testing efficiency of the second stage filtering.

### TECHNICAL FIELD

This disclosure relates to air filtering, and in particular to a method and system for determining efficiency of filter materials positioned in one or more filtering stages in a filtering system.

### INTRODUCTION

Some conventional filtering systems use a filter to remove unwanted particles from air (e.g., lead). Air comprising the unwanted particles is passed through the filter that collects at least some of the unwanted particles, i.e., removing some of the unwanted particles from the air. The efficiency of the filter may be determined based on how many of the undesired particles the filter can collect per a set volume of filtered air.

Some methods used to determine filtering system efficiency may include visually inspecting the condition of the filter to visually detect accumulation of undesired particles. It may be particularly challenging to determine the efficiency and efficacy of a filter based upon this type of analysis and evaluation. For example filter efficiency generally refers to the ability of a filter to capture various particles in a set period of time. Filter effectiveness generally refers to the ability of a filter and/or filtration system to remove particles in a space. The condition of the filter may not accurately reflect whether the filtered air still contains undesired particles in a way that exceeds a threshold. Also, a visual inspection may not provide information of the ability of a filter to capture certain particles in a single class. Also, at times in a particular environment, various filters may be placed sequentially to filter out the air in various stages. Visually inspecting the filters may not provide information about the efficiency and effectiveness of each filter when it is placed sequentially among other filters. Thus, visually inspecting filters is not an accurate representation of the efficiency and/or effectiveness of a filter. Further, conventional filters only remove a type of particles and may allow other unwanted particles to flow with the filtered air.

### SUMMARY

Some embodiments advantageously provide a method and system for determining efficiency of one or more filters. More specifically, as conventional filters may not be effective at removing a wide array of particles, different filters may be arranged in stages, where air is first filtered in a first stage using a first filter, followed by another filter (i.e., second stage), a third filter (i.e., third stage), etc. However, determining the arrangement of filters (to obtain a predetermined filter efficiency) may be difficult using conventional technology.

According to one aspect, a testing system may comprise a first filter arranged to receive air and perform a first stage filtering of the air. The system may further comprise a second filter in fluid communication with the first filter and arranged to receive air from the first filter after the first stage filtering is performed and to perform a second stage filtering of the air. A first sampling filter may be positioned between the first and second filters, arranged to receive the air that is effluent from the first filter after the first stage filtering is performed, and arranged for testing removal efficiency of the first stage filtering. A second sampling filter may be arranged to receive the air that is effluent from the second filter after the second stage filtering is performed and arranged for testing removal efficiency of at least the second stage filtering. The removal efficiency of the second stage filtering at least may correspond to a capability of the testing system to detect particles in the air that are smaller than a predetermined particle size.

In some embodiments, the testing system further comprises a first sample port, a second sample port, and a third sample port in fluid communication with the first filter, the second filter, the first sampling filter, and the second sampling filter.

In some embodiments, one or more of the first, second, and third sample ports are arranged for measurement of volumetric flow of the air for the testing of the efficiency of one or both of the first stage filtering and the second stage filtering.

In some embodiments, each of the first, second, and third sample ports include at least one sensor and at least one corresponding sampling filter.

In some other embodiments, the first sampling filter is disposed in the first sample port and the first sample port is positioned after the first filter and before the second filter to receive the air that is effluent from the first filter after the first stage of filtering is performed.

In some embodiments, the second sampling filter is disposed in the second sample port and second sample port is located after the second filter to receive the effluent from the second filter after the second stage of filtering is performed.

In some embodiments, the system further comprises a pipe and an inlet where unfiltered air enters into the testing system and a third sampling filter that is disposed in the third sample port, the third sample port is positioned proximate the inlet and before the first and the second filters to receive the unfiltered air before it enters into the testing system.

In some embodiments, the system further comprises an outlet that is disposed after the second sample port to receive the effluent from the second filter after the second stage of filtering is performed.

In some embodiments, the system further comprises a third filter in fluid communication with the second filter and arranged to receive air from the second filter after the second stage filtering is performed and to perform a third stage of filtering of the air.

In some embodiments, the system further comprises a fourth sampling filter disposed in a fourth sample port, the fourth sample port is positioned after the third filter and arranged to receive the effluent from the third filter after the third stage of filtering is performed.

In some embodiments, the testing system further comprises one or more valves arranged for bypassing one or both of the first and second filters.

In some embodiments, the first sampling filter and the second sampling filter are arranged to collect the particles in the air that are not collected by the first and second filters, respectively.

In some other embodiments, the testing system further comprises a control system configured to determine the efficiency of the first stage filtering and the second stage filtering based at least in part on the collected particles and volumetric flow of air before and after the first stage filtering and the second stage filtering.

According to another aspect, a testing system comprises a first filter arranged to receive air and perform a first stage filtering of the air. The system may further comprise a second filter in fluid communication with the first filter and arranged to receive air from the first filter after the first stage filtering is performed and to perform a second stage filtering of the air. A first sampling filter may be positioned between the first and second filters, arranged to receive the air that is effluent from the first filter after the first stage filtering is performed, and arranged for testing removal efficiency of the first stage filtering. A second sampling filter may be arranged to receive the air that is effluent from the second filter after the second stage filtering is performed and arranged for testing removal efficiency of at least the second stage filtering. The removal efficiency of the second stage filtering may at least correspond to a capability of the testing system to detect particles in the air that are smaller than a predetermined particle size. A control system may be configured to determine the removal efficiency of the first stage filtering and the second stage filtering based at least in part on the collected particles and volumetric flow of air before and after the first stage filtering and the second stage filtering.

In some embodiments, the testing system further comprises a first sample port, a second sample port, and a third sample port in fluid communication with the first filter, the second filter, the first sampling filter, and the second sampling filter.

In some other embodiments, one or more of the first, second, and third sample ports are arranged for measurement of volumetric flow of the air for the testing of the efficiency of one or both of the first stage filtering and the second stage filtering.

In some embodiments, the testing system further comprises a third filter arranged to receive air from second filter after the second stage filtering is performed and to perform a third stage of filtering of the air.

In some other embodiments, the third filter is a high efficiency particulate air (HEPA) filter.

In some embodiments, the testing system further comprises one or more valves arranged for bypassing at least one or both of the first and second filters.

According to one aspect, a method in a testing system is described. The testing system may comprise a first filter associated with a first stage filtering, a second filter associated with a second stage filtering, a first sampling filter associated with a first efficiency of the first stage filtering, and a second sampling filter associated with a second efficiency of the second stage filtering. The method may comprise: determining one or more of a first volumetric flow of air associated with the first filter; a second volumetric flow of the air associated with the first and second filter; a third volumetric flow of the air associated with the second filter; collecting first particles using the first sampling filter after the first stage filtering and second particles using the second sampling filter after the second stage filtering; and determining an efficiency of one or more of the first stage filtering and the second stage filtering based on one or more of the first volumetric flow, the second volumetric flow, the third volumetric flow, the first particles, and the second particles.

According to one aspect, a testing system comprising a first filter, a second filter, a third filter, and a fourth filter is described. The first filter is arranged to receive air and perform a first stage filtering of the air. The second filter is arranged to receive air from the first filter after the first stage filtering is performed and to perform a second stage filtering of the air. The third filter is positioned between the first and second filters, arranged to receive the air from the first filter after the first stage filtering is performed, and arranged for testing efficiency of the first stage filtering. The fourth filter is positioned past the second filter, arranged to receive the air from the second filter after the second stage filtering is performed, and arranged for testing efficiency of the second stage filtering.

According to another aspect, a method in a testing system is described. The testing system comprises a first filter associated with a first stage filtering, a second filter associated with a second stage filtering, a third filter associated with a first efficiency of the first stage filtering, and a fourth filter associated with the second efficiency of the second stage filtering. The method comprises determining one or more of a first volumetric flow of air associated with the first filter; a second volumetric flow of the air associated with the first and second filters; a third volumetric flow of the air associated with the second filter. The method further includes collecting first particles using the third filter after the first stage filtering and second particles using the fourth filter after the second stage filtering. In addition, the method includes determining an efficiency of one or more of the first stage filtering and the second stage filtering based on one or more of the first volumetric flow, the second volumetric flow, the third volumetric flow, the first particles, and the second particles.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example testing system according to one embodiment of the present disclosure;

FIG. 2 shows an example sample port according to one embodiment of the present disclosure;

FIG. 3 shows an example control system according to one embodiment of the present disclosure;

FIG. 4 is a flowchart illustrating an example method of determining efficiency according to one embodiment of the present disclosure;

FIG. 5 shows another example testing system according to one embodiment of the present disclosure; and

FIG. 6 shows another example testing system coupled to a pathway and a dust collector according to one embodiment of the present disclosure.

### DETAILED DESCRIPTION

One or more embodiments describe a testing system (e.g., testing platform). The testing system may be arranged to measure removal efficiency by the one or more filters (e.g., filter materials). The one or more filters may be situated in a primary, secondary, and/or tertiary position. However, it will be understood that the one or more filters may be arranged in various configurations in the primary, secondary, and/or tertiary position. The testing system may comprise instrumentation such as sensors, control units, and control systems. Further, the testing system may comprise one or more sampling ports arranged for determining collection efficiency (and/or removal efficiency) and operating parameters of one or more filtering stages.

Before describing in detail exemplary embodiments, it is noted that the embodiments reside primarily in combinations of apparatus components and processing steps related to battery thermal management. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term to “couple” (and/or coupled and/or coupling) is used and may refer to at least to joining, affixing, attaching, connecting, placing in contact, bringing in contact two or more elements or components.

In some embodiments, the term filter may be used and may refer to an element arranged for filtering one or more fluids such as air. The filter may trap contaminants such as airborne particles, pollutants, micro-organisms, and other contaminants. A filter may comprise a high efficiency particulate air (HEPA) filter, a filter bag, an electrostatic filter, a washable filter, a media filter, a spun glass filter, a fiberglass filter, a pleated filter, a sampling filter, an ultra violet light filter, a test strip, etc. A filter may refer to a filter that is capable of collecting and/or sampling airborne particles, pollutants, micro-organisms, and other contaminants in the air. A filter may be arranged to collect and/or sample particles based on a variety of different criteria such as particle size and/or type, a filtration performance requirement, matching the filter to air-movement requirements, certain standards and/or specifications, and/or any other parameter. The collection may be performed at least in part by passing the air through the filter. The sampling may be performed manually and/or via a control system and/or sensor. In some embodiments, where the filter is a sampling filter, for example a sampling filter may be designed to sample particulates and/or aerosols in the air for monitoring and/or research applications, the sampling filter may be arranged for collecting particles that are not collected by another filter and this can be used to determine the efficiency such as removal efficiency of another filter.

Further, a filter may have an influent side and/or an effluent side (e.g., with respect to air flow). The influent side may refer to a side that initially receives the air. The effluent side may refer to a side where the air that has been filtered (by passing through the filter) flows after it has been received by the influent side. In other words, the influent side may refer to the side that receives incoming flow of air, and the effluent side may refer to the side of the filter where filtered air flows out of the filter. In some embodiments, the influent side may refer to unfiltered side, and the effluent side may refer to the filtered side. With respect to the air (i.e., fluid), influent air may refer to unfiltered air and/or air that is received by the influent side of the filter. Effluent air may refer to filtered air and/or air that flows out of the effluent side of the filter.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the relevant art and will not be interpreted in an idealized or overly formal sense unless expressly so defined herein.

Some of the embodiments contemplated herein will now be described more fully with reference to accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

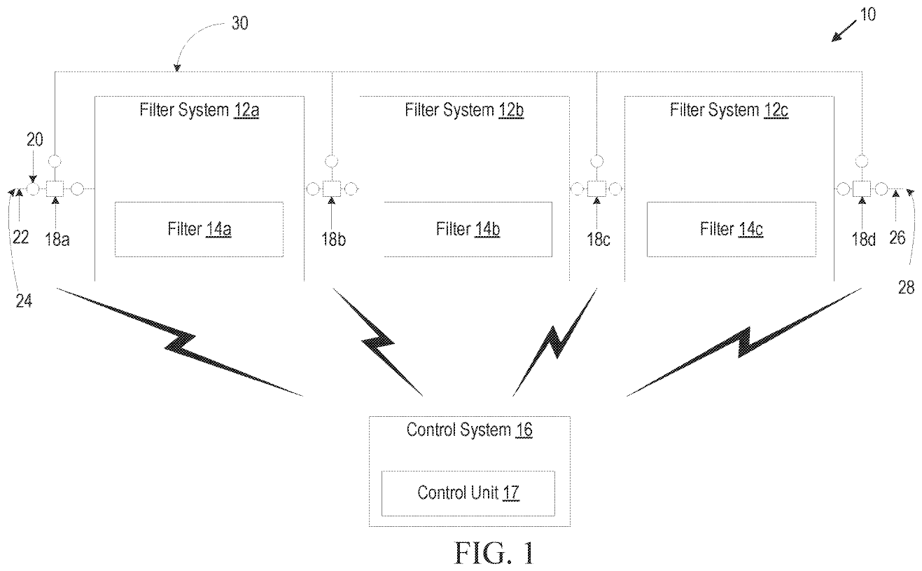

Referring now to the drawing figures in which like reference designators refer to like elements, some embodiments provide a testing system as illustrated in FIG. 1. The testing system 10 may comprise one or more filter systems 12 (e.g., such as the exemplary testing system 10 with filter systems 12a, 12b, 12c) (filter systems 12a, 12b, 12c, etc., are collectively referred to herein as “filter systems 12”). Each filter system 12 may have one or more filters. In the nonlimiting example of FIG. 1, filter system 12a may comprise filter 14a, filter system 12b may comprise filter 14b, and filter system 12c may comprise filter 14c (filters 14a, 14b, 14c, etc. are collectively referred to herein as “filters 14”). Filters 14 may be removable, movable, replaceable, fixed, etc. Each filter 14a, 14b, and/or 14c may include one filter or a plurality of filters depending upon what the testing system 10 is being used for. Accordingly, filter system 12a may have a plurality of filters in filter 14a. Filters 14 may have one or more characteristics such as size, dimensions, volume, capability to remove one or more particles (such as contaminants), rating, filtering area, filtering capacity, filtering efficiency, collection efficiency, removal efficiency, etc. The characteristics of the filters 14 may be based upon the particles that are to be filtered, various environmental conditions as well as other characteristics of the testing system 10. Filter 14 may comprise a high efficiency particulate air (HEPA) filter, a filter bag, an electrostatic filter, a washable filter, a media filter, a spun glass filter, a fiberglass filter, a pleated filter, etc.

Further, testing system 10 may comprise control system 16, which may include control unit 17 configured to perform one or more functions described herein with respect to testing system 10 such as communicate with one or more elements of testing system 10 and/or determine at least one parameter associated with testing system 10 (e.g., determining a filtering efficiency of any of filter systems 12 and/or filters 14).

Further, testing system 10 may have one or more sample ports 18, which may be located in predetermined locations of testing system 10. For example, sample port 18a may be located in an inlet location (e.g., on an inlet pipe) of filter system 12a. Sample port 18b may be located between an outlet location (e.g., on an outlet pipe) of filter system 12a and an inlet location (e.g., on an inlet pipe) of filter system 12b. Sample port 18c may be located between an outlet location (e.g., on an outlet pipe) of filter system 12b and an inlet location (e.g., on an inlet pipe) of filter system 12c. Further, sample port 18d may be located in an outlet location (e.g., on an outlet pipe) of filter system 12c. (sample ports 18a, 18b, 18c, etc. are collectively referred to herein as “sample ports 18”)

In addition, testing system 10 may have one or more valves 20 arranged to control flow of a fluid such as air passing through inlet pipe 22 or any other pipe (e.g., outlet pipe 26). In one nonlimiting example, the inlet pipe 22 may have an inlet rate of less than 20 gr/ft³ . Valves 20 may be located in various predetermined locations with respect to sample ports 18 and/or filter systems 12 to allow fluid (e.g., air) to pass through filter systems 12 or a bypass may be created (e.g., reroute air to a different filtering system 12 or pipe) via a bypass pipe 30. For example, unfiltered air 24 that is entering testing system 10 may be routed to one or more filter system 12 using valves 20, inlet pipe 22, outlet pipe 26, etc. The unfiltered air 24 that is entering the testing system 10 may be at the ambient temperature and a particular rate. In one nonlimiting example, the ambient temperature may be between 60° F. and 90° F. and the airflow of the unfiltered air 24 into the pipe 22 may be at a rate of 1000 actual cubic feet per minute (“ACFM”). The routed air (e.g., filtered air 28) may exit the testing system via outlet pipe 26. In some embodiments, the filtered air 28 may not be filtered as it may bypass certain portions of the testing system 10 via bypass pipe 30.

Although three filter systems 12 are shown in this exemplary embodiment, testing system 10 may comprise any quantity of filter systems 12 (and/or filters 14), which can be arranged in various configurations.

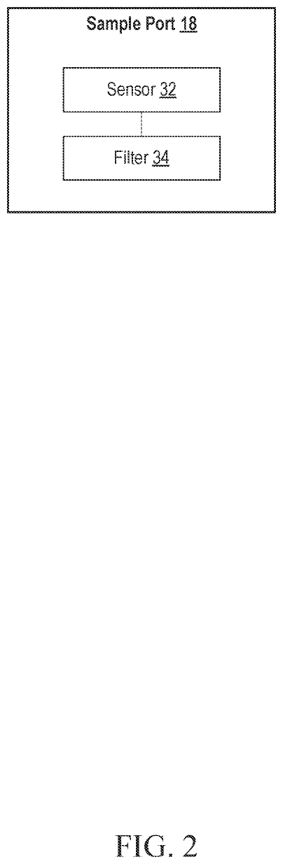

FIG. 2 shows an example sample port 18. Sample port 18 may be arranged to couple to (or be comprised in) any component of testing system 10 including but not limited to pipes, filter systems 12, valves 20, etc. Further, sample port 18 may be configured to receive and/or comprise sensor 32 and/or filter 34. Filter 34 may include a sampling filter, a testing strip, etc. Sensor 32 may be configured to measure any parameter including the measurement of particulate matter, various gasses as well as other parameters including pressure, volume, temperature, flow, humidity, ultra violet illumination, and any other parameter associated with fluids components, particles, etc. Although sensor 32 and/or filter 34 are shown as part of sample port 18, sensor 32 and/or filter 34 may be located anywhere in the system 10 and/or be standalone.

Filter 34 may be arranged to collect one or more components in a gas such as air (e.g., unfiltered air, filtered air, etc.). For example, filter 34 may be arranged to collect one or more particles associated with air passing through testing system 10 such as particles in unfiltered air 24, air passing between filter systems 12, and/or filtered air 28. Further, filter 34 may be arranged to collect particles based on a collection criteria such as particle size as well as other collection criteria. Filter 34 may be used for determining an amount (e.g., concentration), type, weight (or any other parameter) of the collected particles. In some embodiments, filter 34 may be removable from sample port 18 such as to be taken to a laboratory for determining the amount, type, weight (or any other parameter) of the collected particles. Additionally, the sample port 18 including sensor 32 and filter 34 may be removable from the testing system 10. In some other embodiments, the determination of the amount, type, weight (or any other parameter) of the collected particles may be performed by control system 16 such as via control unit 17 and/or sensor 32 (e.g., comprised in sample port 18).

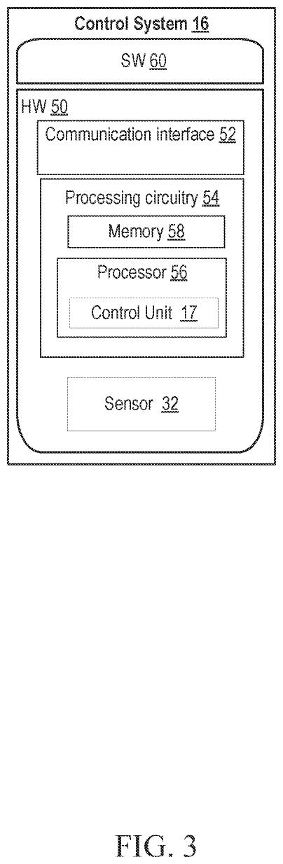

FIG. 3 shows an example control system 16 according to some embodiments of the present disclosure. Control system 16 may have hardware 50 that may include a communication interface 52 that is configured to communicate with one or more entities in testing system 10 via wired and/or wireless communication such as sensors 32 and/or valves 20. The communication may be protocol-based communications.

The hardware 50 includes processing circuitry 54. The processing circuitry 54 may include a processor 56 and memory 58. In particular, in addition to or instead of a processor, such as a central processing unit, and memory, the processing circuitry 54 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 56 may be configured to access (e.g., write to and/or read from) memory 58, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the control system 16 may further comprise software 60, which is stored in, for example, memory 58, or stored in external memory (e.g., database, etc.) accessible by the control system 16. The software 60 may be executable by the processing circuitry 54.

The processing circuitry 54 may be configured to control any of the methods and/or processes described herein and/or to cause such methods, and/or processes to be performed, e.g., by control system 16. The processor 56 corresponds to one or more processors 56 for performing control system 16 functions described herein. The memory 58 may be configured to store data, programmatic software code and/or other information described herein. In some embodiments, the software 60 may include instructions that, when executed by the processor 56 and/or processing circuitry 54, causes the processor 56 and/or processing circuitry 54 to perform the processes described herein with respect to control system 16. For example, the processing circuitry 54 of the control system 16 may include control unit 17 that is configured to perform any step and/or task and/or process and/or method and/or feature described in the present disclosure, e.g., determine one or more parameters associated with system 10 (e.g., determining efficiency such as removal efficiency, collection efficiency, filtering efficiency, causing one or more components of testing system 10 to perform one or more actions, etc.). While control unit 17 is illustrated as being part of control system 16, control unit 17 and associated functions described herein may be implemented in a device separate from control unit 17 such as filter system or another system/device. Further, control system may comprise sensor 32 configured to measure one or more parameters of testing system 10 (e.g., environmental parameters that may be usable for determining removal efficiency). Sensor 32 is not limited to being comprised in control system 16 and may be comprised in any other component of testing system 10 such as sample port 18 and be in communication with control system 16.

In some embodiments, control system 16 may be configured to, such as via control unit 17, sensor 32, and/or communication interface 52, perform measurements associated with testing system 10, make determinations such as determining removal efficiency based on the measurements, and cause one or more components of testing system 10 to perform an action, e.g., by determining and transmitting a control command to a valve or any other component of testing system 10. For example, testing system 10 may have a first filtering arrangement, where one or more filters are arranged in a first order. Control system 16 may measure environmental parameters such as humidity, temperature, pressure of ambient air in a manufacturing facility where the testing system is located and where the air is expected to contain a certain particle. Control system 16 may measure, via sensor 32 and a sampling filter 34, whether at least one filtering stage or filter 14 of the first filter arrangement has a first removal efficiency based on the measurements. Based on the determined removal efficiency, control system 16 may determine a second filter arrangement that is different from the first filter arrangement and that is expected to have a second removal efficiency. Control system 16 may cause valves 20 to actuate (e.g., open, close, throttle, etc.) to change the configuration of filters 14, without having to remove the filters 14, 34 from the testing system. Further, control system 16 may determine the second removal efficiency after the testing system has been arranged per the second filter arrangement. The first and second testing efficiencies may be compared and logged by control system 16. Multiple filter arrangements may be accomplished without having to remove or replace the filters and/or by replacing or replacing filters. For each filter arrangement at least one removal efficiency may be determined. For example, more than one removal efficiency may be determined for a set of environmental parameters.

Further, control system 16 may store (on memory 58) and/or obtain (e.g., via communication interface 52) and/or determine (e.g., via control unit 17) one or more filter characteristics (e.g., filter specification parameters) that may be used to determine the removal efficiency. By having the filter characteristics and information about filter arrangements previously tested, control system 16 may determine other filter arrangements and removal efficiencies.

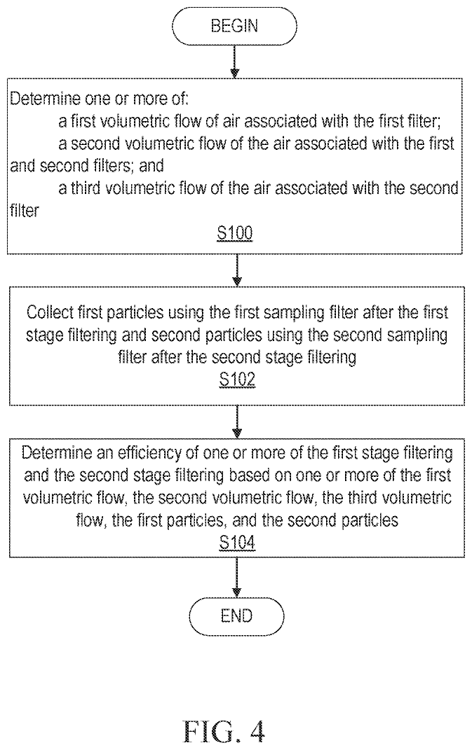

Referring now to FIG. 4, an example method of testing the removal efficiency of one or more filters is described. For example, the removal efficiency of any particular filter may be determined based on how much of certain particles the filter can collect per a set volume of filtered air. The method is associated with a testing system that comprises a first filter associated with a first stage filtering, a second filter associated with a second stage filtering, a first sampling filter associated with a first removal efficiency of the first stage filtering, and a second sampling associated with the second removal efficiency of the second stage filtering. The method comprises determining (Block S100) one or more of a first volumetric flow of air associated with the first filter; a second volumetric flow of the air associated with the first and second filters; a third volumetric flow of the air associated with the second filter. The method further includes collecting (Block S102) first particles using the first sampling filter that is effluent from, i.e., after, the first stage filtering and second particles using the second sampling filter that is effluent from, i.e., after, the second stage filtering. In addition, the method includes determining (Block S104) a removal efficiency of one or more of the first stage filtering and the second stage filtering based on one or more of the first volumetric flow, the second volumetric flow, the third volumetric flow, the first particles, and the second particles.

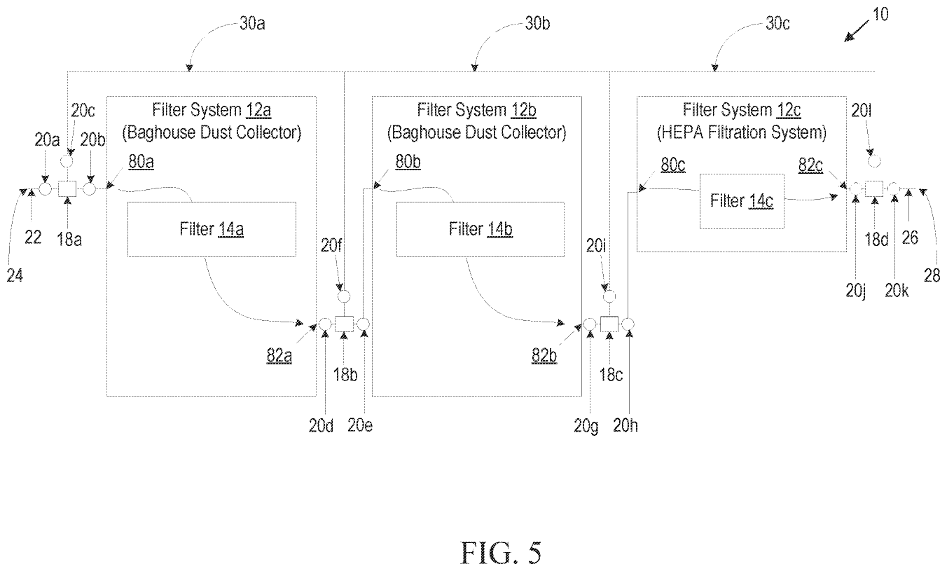

FIG. 5 shows an example testing system 10 according to some embodiments of the present disclosure. In one embodiment, the testing system 10 may be used to filter various particles including but not limited to what may be found in a battery plant which may include lead particles, particles with a diameter of 10 micrometers or less (“PM 10”), and/or particles with a diameter of 2.5 micrograms or less (“PM 2.5”). More specifically, testing system 10 comprises a filter system 12a (e.g., a baghouse dust collector) comprising a filter 14a. The filter system 12a may be made from materials including carbon steel or any other material. It will be understood that the filter system 12a is not limited to a baghouse dust collector and may be another type of system including a cyclone dust collection system, a cartridge dust collector, a wet scrubber dust collection system, and a dust collector. Filter 14a may comprise one or more filter bags arranged to filter at least one component present in air, such as lead. The filter 14a may also filter other parts of the air including other airborne particles, pollutants, micro-organisms, and other contaminants. Filter 14a may have one or more characteristics, such as removal efficiency. Generally, removal efficiency measures the ability of the filter 14a to remove particles from the air stream. These one or more characteristics of filter 14a may also include resistance to airflow and dust-holding capacity. Filter 14a may, in a nonlimiting example, have a total area of 227 square feet, a weight of 1,540 lbs., and a height of 162 and ⅜ inches. Further, testing system 10 may further comprise filter systems 12b, 12c. Filter system 12b may comprise filter 14b which may comprise one or more other filter bags arranged to filter at least one component present in air, such as lead. Filter 14b, in a nonlimiting example, may have a total area of 227 square feet, a weight of 2,390 lbs., and a height of 162 and ⅜ inches. The filter 14b may also filter other parts of the air including other airborne particles, pollutants, micro-organisms, and other contaminants. Filter 14b may have one or more characteristics, such as removal efficiency. Generally, removal efficiency measures the ability of the filter 14a to remove particles from the air stream. These one or more characteristics of filter 14a may also include resistance to airflow and dust-holding capacity. Filter system 12c may comprise filter 14c which may comprise one or more other HEPA filters arranged to filter at least one component present in air, such as lead. The filter 14c may also filter other parts of the air including other airborne particles, pollutants, micro-organisms, and other contaminants. Filter 14c may have one or more characteristics, such as removal efficiency. Generally, removal efficiency measures the ability of the filter 14a to remove particles from the air stream. These one or more characteristics of filter 14a may also include resistance to airflow and dust-holding capacity.

In some embodiments, air such as unfiltered air 24 enters filter system 12a, via inlet 80a, passes through filter 14a, and exits filter system 12a via outlet 82a. When air enters into inlet 80a, in a nonlimiting example, the air flow may be at a rate of 1000 ACFM and the air entering into the inlet 80a may be at a temperature of 70° F. The outlet 82a, in a nonlimiting example, may be a flanged outlet (e.g., where the flange is a ¼″ plate flange) that is substantially 8 inches in diameter. The air continues to filter system 12b, via inlet 80b, passes through filter 14b, and exits filter system 12b via outlet 82b. In a nonlimiting example, when air enters into inlet 80b, the air may enter at a rate of 1,000 ACFM and a temperature of 70° F. In another nonlimiting example, the outlet 82b may be a flanged air outline that is around 10 inches in diameter. Further, the air continues to filter system 12c, via inlet 80c, passes through filter 14c, and exits filter system 12c via outlet 82c. The filtered air 28 exits the testing system via outlet pipe 26. Inlets 80a, 80b, 80c, etc., are collectively referred to herein as “inlets 80” and outlets 82a, 82b, 82c, etc., are collectively referred to herein as “outlets 82”.

In some other embodiments, testing system 10 comprises sample ports 18. More specifically, sample port 18a is coupled to pipe 22a and/or to inlet 80a of filter system 12a, i.e., before the first stage. Put another way, the sample port 18 may be coupled to pipe 22 and/or inlet 80a of filter system 12a such that the sample port 18 may sample unfiltered air 24 before the unfiltered air 24 enters into filter 14a. Sample port 18b is located between filter systems 12a and 12b and/or coupled to outlet 82a and/or inlet 80b, i.e., between the first stage and the second stage. Put another way, sample port 18b may be disposed between filter systems 12a and 12b or it may be disposed proximate outlet 82b or inlet 80b. Sample port 18c is located between filter systems 12b and 12c and/or coupled to outlet 82b and/or inlet 80c, i.e., between the second stage and the third stage. Put another way, sample port 18c may be disposed between filter system 12b and 12c or it may be disposed proximate outlet 82c or inlet 80c. Further, sample port 18d is located on the outlet side of filter system 12c and/or coupled to outlet 82c and/or outlet pipe 26, i.e., after the third stage. Put another way, sample port 18d may be disposed proximate outlet 82c or sample port 18d may be disposed proximate or in communication with outlet pipe 26.

In some embodiments, testing system 10 comprises valves 20, coupled to pipes and/or sample ports 18 and/or inlets 80 and/or outlets 82. Each valve 20 may receive signaling from control system 16 and/or regulate the airflow within the testing system 10. In this nonlimiting example, air such as unfiltered air 24 may enter the testing system 10 via inlet pipe 22. Valves 20a, 20b are in an open position, while valve 20c is in a closed position (valves 20a, 20b, 20c, etc., are collectively referred to herein as “valves 20”). With this configuration of open and closed valves 20, the unfiltered air 24 is moved through pipe 22 and into filter system 12a. Thus, unfiltered air 24 enters filter system 12 via inlet 80a (coupled to inlet pipe 22), passes through filter 14a and exits filter system 12 via outlet 82. The unfiltered air 24 does pass into bypass pipe 30 with valves 20a, 20b in the open position and valve 20c in the closed position. The air, filtered in the first stage (i.e., via filter 14a), enters filter system 12b (e.g., another baghouse dust collector) via inlet 80b (as valves 20d, 20e are open, and valve 20f is closed). The air that has been filtered in the first stage (via filter 14a) does not enter into the bypass pipe 30 with valves 20d and 20e open and 20f in the closed position. The air passes through filter 14b (e.g., second stage), exits filter system 12b via outlet 82b, and continues to filter system 12c (as valves 20g, 20h are open, and valve 20i is closed). The air that has been filtered in the second stage (via filter 14b) does not enter into the bypass pipe 30 with valves 20g and 20h open and valve 20i in the closed position. Further, the air passes through filter 14c (e.g., third stage, HEPA filter) and exits filter system 12c (as filtered air 28) via outlet 82c out to outlet pipe 26 (as valves 20j, 20k are open, and valve 201 is closed). The air that has been filtered in the third stage (via filter 14c) does not enter into bypass pipe 30 with valves 20j and 20k open and valve 201 in the closed position. In other words, unfiltered air 24 is filtered using three stages (filters 14a, 14b, 14c). The unfiltered air 24 does not enter into the bypass pipe 30 given the valves which are opened and those that are closed within the testing system 10.

In some other embodiments, removal efficiency of the filter systems 12 may be determined via control system 16, sample ports 18, valves 20, and/or any other component. More specifically, testing system 10 may comprise one or more sample ports 18 located before or after different filtering stages. The one or more sample ports 18 may be located before and/or after the first stage, one or more sample ports 18 may be located before and/or after the second stage, and one or more sample ports 18 may be located before and/or after the third stage. As a non-limiting example, the one or more sample ports 18 may be disposed before and/or after each filter system 12. Each sample port 18 may comprise a sensor 32 and/or filter 34 (e.g., testing strip). Filter 34 may be configured to collect more components of air per volume of air than another filter 14. For example, a filter 34 comprised in sample port 18b may be arranged to collect more particles than filter 14b such that air that has passed filtered 14 is tested and/or the removal efficiency of filter 14a is tested. Stated another way, filter 34 may be located within sample port 18b and filter 34 may be capable of collecting more airborne particles, pollutants, micro-organisms, and other contaminants than filter 14a. Therefore, when air passes through filter 34 that is located within sample port 18b, filter 34 can test the removal efficiency of filter 14a. Also, there may be a filter 34 that is disposed within sample port 18c and this filter 34 may be capable of collecting more airborne particles, pollutants, micro-organisms, and other contaminants than filters 14a and 14b. Therefore when air passes through filter 34 that is located within sample port 18c, filter 34 can test the removal efficiency of filters 14a and filter 14b. Also, filter 34 may be located within sample port 18d and filter 34 may be capable of collecting more airborne particles, pollutants, micro-organisms, and other contaminants than filters 14a and/or 14b, and/or 14c. Therefore when air passes through filter 34 that is located within sample port 18d, filter 34 can test the removal efficiency of filter 14a and/or filter 14b, and/or 14d. Furthermore sample port 18a may be disposed proximate inlet for the pipe 22 that takes in the unfiltered air 24 so that filter 34 in sample port 18a may be capable of collecting the airborne particles, pollutants, micro-organisms, and other contaminants contained in the unfiltered air 24. Other filters 34 may be similarly arranged.

In some embodiments, filters 34 may be used for determining a parameter of filter 34 (and/or corresponding filter 14) such as a number of particles collected by filters 34 (or not collected by filters 14) and/or a removal efficiency of filters 14. For example, filters 34 may be removed for testing to be performed in a laboratory and/or used in conjunction with sensor 32 for control system 16 to perform the testing.

In some other embodiments, control system 16 is configured to determine a removal efficiency of filters 14 by measuring a parameter (e.g., via sensor 32) such as volumetric flow of air passing through sample port 18 and/or the amount of collected particles in filter 34. More specifically, the removal efficiency of filter 14a may be determined based on the volumetric air flow in sample port 18a and/or sample port 18b and an amount and/or type of particles collected by filter 34a and filter 34b (comprised in the corresponding sample ports 18a, 18b). Similarly, the removal efficiency of filter 14b may be determined based on the volumetric air flow in sample port 18b and/or sample port 18c and the amount and/or type of particles collected by filter 34b and filter 34c (comprised in the corresponding sample ports 18b, 18c). Further, the removal efficiency of filter 14c may be determined based on the volumetric air flow in sample port 18c and/or sample port 18d and the amount and/or type of particles collected by filter 34c and filter 34d (comprised in the corresponding sample ports 18c, 18c). Any other combination of parameters may be used to determine removal efficiency.

The control system 16 may be configured to modify certain characteristics of the testing system 10 based upon certain preset parameters that are measured and/or determined in the testing system 10. For example, the removal efficiency of filter 14a may be determined based upon the volumetric air flow in sample port 18a and/or sample port 18b, for example, via each sensor 32 contained in sample port 18a and 18b and an amount and/or type of particles collected by filter 34a and filter 34b (comprised in the corresponding sample ports 18a, 18b). The control system 16 may have a first preset volumetric flow parameter and if the control system 16 detects that the measurement is greater than the first preset volumetric flow parameter, certain characteristics of the filter system 12a may be arranged in a first configuration. If the control system 16 detects that the measurement is less than the first preset volumetric flow parameter, certain characteristics of the filter system 12a may be arranged in a second configuration. As another example, the removal efficiency of filter 14b may be determined based upon the volumetric air flow in sample port 18b and/or sample port 18c and an amount and/or type of particles collected by filter 34b and filter 34c (comprised in the corresponding sample ports 18b, 18c). The control system 16 may have a second preset volumetric flow parameter and if the control system 16 detects that the measurement is greater than the second preset volumetric flow parameter, certain characteristics of the filter system 12b may be arranged in a third configuration. If the control system 16 detects that the measurement is less than the second preset volumetric flow parameter, certain characteristics of the filter system 12b may be arranged in a fourth configuration. As yet another example, the control system 16 may have a third preset volumetric flow parameter and if the control system 16 detects that the measurement is greater than the third preset volumetric flow parameter, certain characteristics of the filter system 12a may be arranged in a fifth configuration. If the control system 16 detects that the measurement is less than the third preset volumetric flow parameter, certain characteristics of the filter system 12c may be arranged in a sixth configuration. Additionally, it will be understood that the configuration of the various components may be modified in a variety of different ways based upon the preset parameters in the control system 16. For example, certain parameters related to environmental conditions within the testing system 10 may also be preset. The configurations of the various components in filter system 12a, 12b, and 12c may be arranged and/or changed based upon the preset parameters related to environmental conditions. Additionally, it will be understood that the configuration of the various components may be modified in a variety of different configurations as well based upon various preset parameters.

In some embodiments, one or more filter systems 12 may be bypassed (partially, or entirely) such as for further testing. For example, the efficiency of filters 14 (e.g., filters 14b, 14c) may be determined by bypassing filter system 12a. In some embodiments, bypassing (partially or entirely) one or more filter systems 12 may yield a better removal efficiency than when the entirety of the air passes by each filter system 12. Bypassing may be performed at least by operating one or more valves 20.

In some other embodiments, control system 16 may be configured to operate valves 20 to route at least a portion of the air, such as to test efficiency of one or more of filters 14a, 14b, 14c. For example, at least a portion of the air to be filtered by filter 14a may be routed around filter system 12a via bypass pipe 30a. Similarly, at least a portion of the air to be filtered by filter 14b may be routed around filter system 12b via bypass pipe 30b, and at least portion of the air to be filtered by filter 14c may be routed around filter system 12b via bypass pipe 30c. In some embodiments, efficiency of at least one filter 14 may change based on the volume of air bypassed.

In some embodiments, the removal efficiency of various filter combinations may be determined in a production environment (e.g., in a battery manufacturing plant). In some other embodiments, a testing system for testing removal efficiency of filter systems arranged for removal of undesired particles such as lead and/or particles with a diameter of 10 microns or less (PM10) is described. In some embodiments, the testing system may be arranged for testing based on PM2.5 emissions controls. PM2.5 may refer to particles with a diameter of 2.5 microns or less.

In some other embodiments, a predetermined volume of air may be extracted from a production process (e.g., postproduction/pre filtration), measure one or more parameters of the extracted air, and direct it through two separate stages of filters and discharge the air back into an existing dust collector. The testing system may be configured to allow swapping out of different filter materials in the first and second stages and allow for sample collection before the first stage, between the first and second stage, and then again after the second stage. In some embodiments, data reflecting the capture efficiency of different filter materials may be obtained and provide insights into pathways for further emissions reductions. In some embodiments, Polytetrafluoroethylene (PTFE) coated bags may be used as a filter 14 which may be combined with other filters in other stages and tested using testing system 10. In some other embodiments, testing system 10 may be arranged to provide data usable for driving emissions to zero.

One or more embodiments of the present disclosure are beneficial at least because removal efficiency of each filtering stage (e.g., filters 14a, 14b, 14c) may be determined, e.g., using sample ports 18, valves 20, sensors 32, and/or filters 34, etc. Further, determining removal efficiency of filtering stage allows for determining a configuration of filters 14 that yields a removal efficiency greater than a removal efficiency threshold.

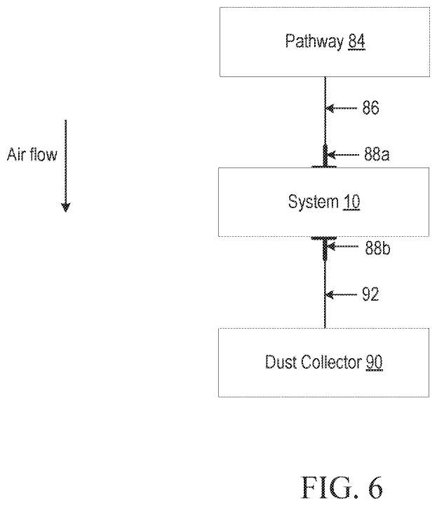

In one embodiment, system 10 could be used in the production process of lead acid batteries to assess the removal efficiency of various filter combinations in a battery plant. The system 10 could be in communication with (e.g., in fluid communication with, coupled to, etc.) a portion of the battery production plant to pull a volume of air from a part of the production and direct the air through the system 10 and then discharge the air after it has moved through the system 10. As shown in FIG. 6, one nonlimiting example may be where the system 10 is in communication with a pathway 84. The pathway 84 may include any type of pathway that is involved in the production and manufacturing process for batteries or other components that produces particular matter into the air. As one example, pathway 84 may include an exhaust 86 which is integrated into pathway 84 and the exhaust 86 may collect gasses, substances, noises, and other discharges from the pathway 84. The exhaust 86 may take any solids, liquids, and/or gasses that are discharged from the pathway 84 so that they are not released into the surrounding environment. One or more connectors 88 may be used (e.g., connector 88a, 88b, etc.). The connector 88 in one embodiment may be a T connector. Further, the connector 88a may be in alignment with the exhaust 86 and the connector 88a may connect the exhaust 86 to system 10. In cases where the use of multiple systems 10 is desired, the T connector (as connector 88) can be used to connect exhaust 86 to system 10. In these cases, the T connector may be used to fluidly connect exhaust 86 to more than one system 10. For example, connector 88a may connect exhaust 86 to the system 10 or the connector 88a may connect exhaust 86 to a plurality of systems 10. The connector 88a may be connected to pipe 22 as part of system 10 or another component within the system 10 so that air from the exhaust 86 is directed into the system 10 and not into the outside environment. The system 10 can take the air from the exhaust 86 and direct air into the system 10 (or a plurality of systems 10) so that the air from the exhaust 86 goes through the system 10. The air that enters into system 10 can be directed to a variety of different pathways within the system 10 so that the air can be filtered through system 10. Connector 88b, which may be a T connector, may connect the outlet pipe 26 from the system 10 to dust collector 90 (and/or dust collector pipe 92). To the extent a T connector is used, the system 10 may be connected to one dust collector 90 (and/or dust collector pipe 92) or a plurality of dust collectors 90 and/or dust collector pipes 92. Accordingly, when any air exits the outlet pipe 26 from system 10, the air will flow directly from connector 88b to dust collector 90 (or plurality of dust collectors 90) so that any air from pathway 84 is directed to the system 10 and then into the dust collector 90. Although air is shown flowing from pathway 84 through system 10 and into dust collector 90, the embodiments of the present disclosure are not limited as such and any other air flow direction is possible. As noted above, although not shown in FIG. 6, it is contemplated that a plurality of systems 10 and/or a plurality of dust collectors 90 may be part the airflow from pathway 84.

System 10 may be used in association with a variety of different components and parts that may release solids, liquids, and/or gasses into the environment. System 10 (or a plurality of systems 10) may be placed in communication with a particular component, such as a particular operating environment for a set period of time, and system 10 (or a plurality of systems) can be in place as part of filtering the air for a predetermined period of time. This may allow for the real time collection of information and data from system 10 about the air that is entering, being filtered, and exiting system 10. Once the predetermined period of time has been met, then the system 10 may be removed from the particular component and then system 10 may be evaluated to determine filtering efficiency and to measure one or more parameters of the extracted air. System 10 may then be placed in communication with another component, such as another operating environment for another set period of time, and system 10 can be set in place as part of the air filtering process for a predetermined period of time. Once the predetermined period of time has been met, then the system 10 may be disconnected from other components and then system 10 may be evaluated to determine filtering efficiency and to measure one or more parameters of the extracted air. Use of system 10 in association with various different components allows for the evaluation of various different components and what solids, liquids, and/or gasses are being extracted from the different components. Also, the filtering efficiency and the removal efficiency of various filter combinations may be determined in a production environment (e.g., in a battery manufacturing plant).

Some embodiments are described herein with reference to flowchart illustrations and/or block diagrams of methods of manufacturing and/or assembling. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings and the following claims.

1. A testing system, comprising:
a first filter arranged to receive air and perform a first stage filtering of the air;
a second filter in fluid communication with the first filter and arranged to receive air from the first filter after the first stage filtering is performed and to perform a second stage filtering of the air;
a first sampling filter positioned between the first and second filters, arranged to receive the air that is effluent from the first filter after the first stage filtering is performed, and arranged for testing removal efficiency of the first stage filtering; and
a second sampling filter arranged to receive the air that is effluent from the second filter after the second stage filtering is performed and arranged for testing removal efficiency of at least the second stage filtering, the removal efficiency of the second stage filtering at least corresponding to a capability of the testing system to detect particles in the air that are smaller than a predetermined particle size.

2. The testing system of claim 1, wherein the testing system further comprises a first sample port, a second sample port, and a third sample port in fluid communication with the first filter, the second filter, the first sampling filter, and the second sampling filter.

3. The testing system of claim 2, wherein one or more of the first, second, and third sample ports are arranged for measurement of volumetric flow of the air for the testing of the efficiency of one or both of the first stage filtering and the second stage filtering.

4. The testing system of claim 3, wherein each of the first, second, and third sample ports include at least one sensor and at least one corresponding sampling filter.

5. The testing system of claim 1, wherein the first sampling filter is disposed in the first sample port and the first sample port is positioned after the first filter and before the second filter to receive the air that is effluent from the first filter after the first stage of filtering is performed.

6. The testing system of claim 1, wherein the second sampling filter is disposed in the second sample port and second sample port is located after the second filter to receive the effluent from the second filter after the second stage of filtering is performed.

7. The testing system of claim 2, wherein the system further comprises a pipe and an inlet where unfiltered air enters into the testing system and a third sampling filter that is disposed in the third sample port, the third sample port is positioned proximate the inlet and before the first and the second filters to receive the unfiltered air before it enters into the testing system.

8. The testing system of claim 6, wherein the system further comprises an outlet that is disposed after the second sample port to receive the effluent from the second filter after the second stage of filtering is performed.

9. The testing system of claim 7, wherein the system further comprises a third filter in fluid communication with the second filter and arranged to receive air from the second filter after the second stage filtering is performed and to perform a third stage of filtering of the air.

10. The testing system of claim 9, wherein the system further comprises a fourth sampling filter disposed in a fourth sample port, the fourth sample port is positioned after the third filter and arranged to receive the effluent from the third filter after the third stage of filtering is performed.

11. The testing system of claim 1, wherein the testing system further comprises one or more valves arranged for bypassing one or both of the first and second filters.

12. The testing system of claim 1, wherein the first sampling filter and the second sampling filter are arranged to collect the particles in the air that are not collected by the first and second filters, respectively.

13. The testing system of claim 12, wherein the testing system further comprises a control system configured to determine the efficiency of the first stage filtering and the second stage filtering based at least in part on the collected particles and volumetric flow of air before and after the first stage filtering and the second stage filtering.

14. A testing system, comprising:
a first filter arranged to receive air and perform a first stage filtering of the air;
a second filter in fluid communication with the first filter and arranged to receive air from the first filter after the first stage filtering is performed and to perform a second stage filtering of the air;
a first sampling filter positioned between the first and second filters, arranged to receive the air that is effluent from the first filter after the first stage filtering is performed, and arranged for testing removal efficiency of the first stage filtering;
a second sampling filter arranged to receive the air that is effluent from the second filter after the second stage filtering is performed and arranged for testing removal efficiency of at least the second stage filtering, the removal efficiency of the second stage filtering at least corresponding to a capability of the testing system to detect particles in the air that are smaller than a predetermined particle size; and
a control system configured to determine the removal efficiency of the first stage filtering and the second stage filtering based at least in part on the collected particles and volumetric flow of air before and after the first stage filtering and the second stage filtering.

15. The testing system of claim 14, wherein the testing system further comprises a first sample port, a second sample port, and a third sample port in fluid communication with the first filter, the second filter, the first sampling filter, and the second sampling filter.

16. The testing system of claim 15, wherein one or more of the first, second, and third sample ports are arranged for measurement of volumetric flow of the air for the testing of the efficiency of one or both of the first stage filtering and the second stage filtering.

17. The testing system of claim 14, where the testing system further comprises a third filter arranged to receive air from second filter after the second stage filtering is performed and to perform a third stage of filtering of the air.

18. The testing system of claim 17, wherein the third filter is a high efficiency particulate air (HEPA) filter.

19. The testing system of claim 14, wherein the testing system further comprises one or more valves arranged for bypassing at least one or both of the first and second filters.

20. A method in a testing system, the testing system comprising a first filter associated with a first stage filtering, a second filter associated with a second stage filtering, a first sampling filter associated with a first efficiency of the first stage filtering, and a second sampling filter associated with a second efficiency of the second stage filtering, the method comprising:
determining one or more of:
a first volumetric flow of air associated with the first filter;
a second volumetric flow of the air associated with the first and second filters; and
a third volumetric flow of the air associated with the second filter;
collecting first particles using the first sampling filter after the first stage filtering and second particles using the second sampling filter after the second stage filtering; and
determining an efficiency of one or more of the first stage filtering and the second stage filtering based on one or more of the first volumetric flow, the second volumetric flow, the third volumetric flow, the first particles, and the second particles.
